(19) United States
(12) Patent Application Publication
(10) Pub. No.: US 2012/0144831 A1
(43) Pub. Date: Jun. 14, 2012

(54) METHOD OF GENERATING SUPERHEATED STEAM IN A SOLAR THERMAL POWER PLANT AND SOLAR THERMAL POWER PLANT

(75) Inventors: Jan Fabian FELDHOFF, Stuttgart (DE); Markus ECK, Leonberg (DE)

(73) Assignee: Deutsches Zentrum fuer Luft-und Raumfahrt e.V.

(21) Appl. No.: 13/325,407

(22) Filed: Dec. 14, 2011

Related U.S. Application Data
(63) Continuation of application No. PCT/EP2010/057982, filed on Jun. 8, 2010.

(30) Foreign Application Priority Data
Jun. 15, 2009 (DE) 10 2009 025 455.2

(51) Int. Cl. F03G 6/00; F01K 13/00

(52) U.S. Cl. 60/641.8; 60/653

(57) ABSTRACT

A method of generating superheated steam in a solar thermal power plant is provided, in which in a flow section for heat transfer medium steam is generated by solar energy in an evaporator zone and the steam is superheated by solar energy in a superheater zone. An evaporation end point of the evaporator zone is fixed in position in a control method, in which a spatial temperature gradient in the superheater zone and a temperature in the evaporator zone are determined and the mass flow of heat transfer medium in the flow section is adjusted in dependence upon the temperature gradient and the measured temperature in the evaporator zone.

### CROSS-REFERENCE TO RELATED APPLICATIONS

This application is a continuation of international application number PCT/EP2010/057982 filed on Jun. 8, 2010 and claims the benefit of German application number 10 2009 025 455.2 filed on Jun. 15, 2009, which are both incorporated herein by reference in their entireties and for all purposes.

### FIELD OF THE INVENTION

The invention relates to solar thermal power plant and methods of generating superheated steam in a solar thermal power plant. Within the solar thermal power plant, in a flow section for heat transfer medium, steam is generated by solar energy in an evaporator zone and the steam is superheated by solar energy in a superheater zone.

### BACKGROUND OF THE INVENTION

Solar thermal power plants may have a steam generating stage, wherein the steam generating stage comprises at least one collector branch having a flow section for heat transfer medium comprising an evaporator zone and a superheater zone. At the transition from the evaporator zone to the superheater zone lies the evaporation end point. In principle fluctuating energy inputs caused by fluctuations in the solar radiation may lead to a change of the location of the evaporation end point. Variations of this location, at which the evaporation changes to superheating, may lead to high oscillating temperature gradients in axial direction within a corresponding guide tube. This in turn results in radial and tangential fluctuations. Such temperature gradients cause thermal stresses in the corresponding materials of a guide tube. These thermal stresses sharply reduce the endurance strength of the affected components.

For example from DE 101 52 968 C1 a solar thermal power plant is known, which comprises at least one solar collector branch having an evaporator branch and a superheater branch. A recirculation line is provided, by means of which liquid heat transfer medium from the evaporator branch may be recirculated. In the recirculation concept a separator is provided, which from the two-phase mixture delivered by the evaporator branch separates liquid heat transfer medium and steam from one another, wherein the liquid heat transfer medium is recirculated and the steam is supplied to the superheater. In this way it is possible to fix the evaporation end point.

### SUMMARY OF THE INVENTION

In accordance with the present invention, a method is provided by means of which a low constructional outlay the evaporation end point may be fixed.

In accordance with the invention, an evaporation end point of the evaporator zone is fixed in position in a control method, wherein a spatial temperature gradient in the superheater zone and a temperature in the evaporator zone are determined and the mass flow of heat transfer medium in the flow section is adjusted in dependence upon the temperature gradient and the measured temperature in the evaporator zone.

It has been shown that by using the temperature gradient in the superheater zone and by additionally using a measured temperature in the evaporator zone it is possible to realize stable control, during which the spatial fluctuation range of the evaporation end point lies within a narrow range.

Since for example a separator and a feed device for the recirculation of condensation product are not necessary compared to the recirculation concept, a solar thermal power plant, in which the method according to the invention is implemented, may be realized with lower investment costs.

The overall system in this case has lower heat losses because feed lines and discharge lines to and/or from a corresponding separator are not required.

For example, even in the event of a very fast steep rise of the energy input into a collector branch the shifting of the evaporation end point may be prevented by a rapid increase of the mass flow. In systems with a separator, in such a case a high surplus of liquid heat transfer medium in the evaporator zone is required, which causes higher pumping losses.

The reduction of the material stresses achieved by fixing the evaporation end point allows reliable, long-term operation with a continuous flow concept.

The superheated steam that is generated is used for example to generate electric current or as process steam.

In particular, in order to fix the evaporation end point the mass flow of the heat transfer medium in the flow section is controlled. The mass flow may easily be adjusted by means of controller valves.

A controlled variable in the control method is advantageously the spatial position of the evaporator end point, wherein a reference variable (setpoint value) is a defined location. From the determination of the temperature gradient and the temperature in the evaporator zone the actual value may be determined and from the deviation from the setpoint value a manipulated variable may be generated, with which in turn the mass flow may be adjusted.

In particular a manipulated variable in the control method influences the mass flow of the heat transfer medium in the flow section. The manipulated variable is for example a valve lift of one or more control valves.

In one embodiment, in the control method the temperature gradient and the measured temperature in the evaporator zone are extrapolated to a spatial point of intersection and one or more manipulated variables are determined by means of a deviation of the point of intersection from a preselected spatial position of the evaporation end point. This point of intersection characterizes an actual value and the deviation from the setpoint value generates the manipulated variable.

In an advantageous manner the temperature in the evaporator zone is measured outside of a preheating zone. In the preheating zone the liquid heat transfer medium is still absorbing sensible heat.

The temperature gradient in the superheater zone is advantageously determined from the measured temperatures at at least two spaced-apart locations in the superheater zone. In this way the temperature rise in the superheater zone may be determined. This in turn enables an extrapolation for determining the actual value for the evaporation end point.

In an advantageous embodiment liquid heat transfer medium is injected in a controlled manner into the evaporator zone. In this way the mass flow in the corresponding flow section may be influenced. The control quality may thereby be improved. The speed of control may moreover be sharply increased.

In particular the injection is effected between the temperature measuring point in the evaporator zone and the evaporation end point. This results in an optimized control.

It is further advantageously provided that an outlet temperature at the superheater zone is controlled to a constant value. This leads to an optimized efficiency for a downstream turbine. As a result of the fixing of the evaporation end point the outlet temperature may vary without additional measures. By means of the corresponding control the outlet temperature may be fixed.

In particular for this purpose liquid heat transfer medium is injected in a controlled manner into the superheater zone. The injection quantity determines the outlet temperature.

In accordance with an embodiment of the invention, a solar thermal power plant is provided that in an alternative to the recirculation concept enables a fixing of the evaporation end point.

In the solar thermal power plant in accordance with an embodiment of the invention, a first temperature sensor is provided, which is disposed at the evaporator zone, a second temperature sensor and a third temperature sensor are provided, which are disposed spaced apart from one another at the superheater zone, a mass flow control device is provided, by means of which the mass flow of heat transfer medium in the flow section is adjustable, and a control device is provided, which is connected in a signal effective manner to the first temperature sensor, the second temperature sensor and the third temperature sensor, determines a spatial temperature gradient from a second temperature and a third temperature and correspondingly controls the mass flow control device in order to fix the position of an evaporation end point.

The solar thermal power plant according to the invention has the advantages already described in connection with the method according to the invention.

Further advantageous developments of the solar thermal power plant according to the invention have likewise already been described in connection with the method according to the invention.

In particular, at a start of the flow section a control valve is disposed, which is controlled by the control device. The control valve forms a part of the mass flow control device. By means of the control valve it is easily possible to control the mass flow and hence also easily possible to fix the evaporation end point even under varying irradiation conditions.

In an advantageous embodiment an injection device is provided for injecting liquid heat transfer medium by means of at least one injection point into the evaporator zone. The injection device is part of the mass flow control device. By means of it the mass flow may be adjusted. It is therefore possible to increase the control quality and raise the speed of control.

In particular the injection device is controlled by the control device. In this way the evaporation end point may be fixed in an optimized manner.

In a constructionally advantageous embodiment the injection device comprises a control valve. In this way it is easily possible to influence the mass flow.

The at least one injection point of the injection device advantageously lies between a temperature measuring point of the first temperature sensor and the evaporation end point. This results in an optimized control process.

It is further advantageous if an injection device is provided for injecting liquid heat transfer medium by means of at least one injection point in the superheater zone. In this way, the outlet temperature of superheated heat transfer medium may in particular be adjusted to a constant value.

In an advantageous manner a solar collector device is provided, at which the flow section is disposed. The solar collector device may be configured in different ways. It may for example comprise one or more trough collectors. In principle the realization by means of a tower receiver for example is also possible.

The steam generating stage is in particular connected fluidically to at least one turbine. In this way it is easily possible to generate electric current.

In particular the method according to the invention may be implemented in the solar thermal power plant according to the invention.

### BRIEF DESCRIPTION OF THE DRAWINGS

The description of preferred embodiments serves in connection with the drawings to provide a detailed explanation of the invention.

FIG. 1(a) shows a schematic representation of the flow concept for the solar generation of superheated steam (state of the art);

FIG. 1(b) shows a schematic representation of the recirculation concept for the solar generation of superheated steam (state of the art);

FIG. 1(c) shows schematically the temperature characteristic at a flow section during the generation of superheated steam;

FIG. 2 shows a schematic block diagram representation of a first embodiment of a solar thermal power plant according to the invention;

FIG. 3 shows a schematic block diagram representation of a second embodiment of a solar thermal power plant according to the invention; and

FIG. 4 shows schematically the characteristic of the temperature over the length at a flow section in connection with the embodiment of a method according to the invention.

### DETAILED DESCRIPTION OF THE INVENTION

In a solar thermal power plant heat transfer medium is heated by solar energy. The heated heat transfer medium drives a turbine, with the result that an electric current is generated at a generator.

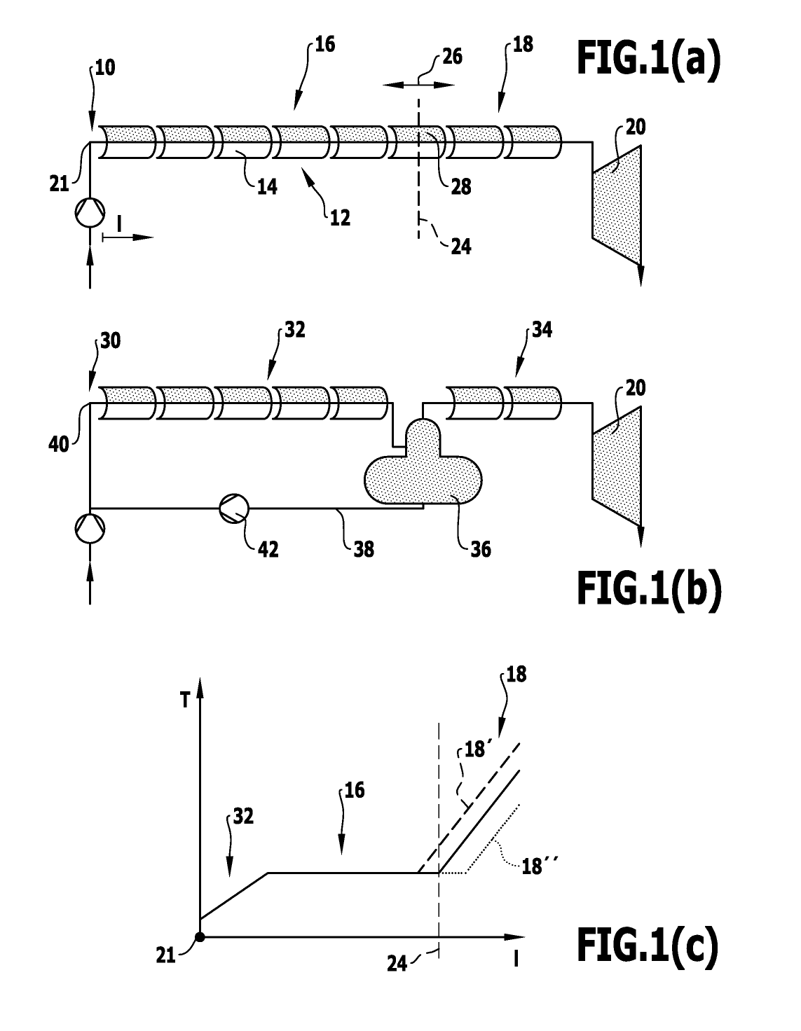

In a continuous flow process (FIG. 1(a)) that is known from the background art, a flow section 10 is provided, at which a solar collector device 12 is disposed. The solar collector device 12 is formed for example by a plurality of trough collectors 14 that are arranged in series. When heat transfer medium flows through these trough collectors 14, concentrated solar radiation is directed onto corresponding absorber pipes and heat transfer medium flowing in the absorber pipes is heated.

In the case of the continuous flow concept, the flow section 10 comprises an evaporator zone 16, in which after a corresponding preheating liquid heat transfer medium is evaporated by solar energy. Adjoining the evaporator zone 16 is a superheater zone 18, at which steam generated in the evaporator zone 16 is superheated. Superheated heat transfer medium exiting from the superheater zone 18 is supplied to a turbine 20.

In FIG. 1(c) the temperature characteristic over the length l along the flow section 10 is shown schematically. A start of the flow section is denoted by 21. In an operating mode with solar irradiation, the start 21 is adjoined firstly by a preheating zone 22, in which a temperature rise and in particular an at least approximately linear temperature rise occurs. This is adjoined by the evaporator zone 16, in which the evaporation occurs. In the evaporator zone 16 the temperature is at least approximately independent of position. The evaporator zone 16 ends at an evaporation end point 24. In the preheating zone 22 the heat transfer medium absorbs sensible heat. In the evaporator zone 16 it absorbs latent heat.

The evaporation end point 24 is followed by the superheater zone 18. In the superheater zone 18 the vaporous heat transfer medium absorbs sensible heat. The temperature rises in the superheater zone along the flow section 10. The rise is at least approximately linear.

In the flow section 10 a direct evaporation occurs. The liquid heat transfer medium introduced into the flow section 10 is pre-heated, evaporated and superheated by solar energy along the flow section 10. The superheated steam is supplied to the turbine 20. In a solar thermal power plant the solar energy input fluctuates. As a result, in the case of the continuous flow concept, such as was described with reference to FIG. 1(a), the location of the evaporation end point 24 varies. This is indicated in FIG. 1(a) by the double arrow having the reference character 26. These variations in the location of the evaporation end point 24 lead to high oscillating temperature gradients inside a pipe 28 of the flow section 10. The oscillation arises initially in axial direction (in a direction parallel to the longitudinal direction of the flow section 10) and, as a result of this, oscillating temperature gradients also arise in radial and tangential direction. These temperature gradients in turn cause thermal stresses in the material of the pipe 28. As a result, the endurance strength of the affected components is reduced.

If, in comparison to the ideal situation, the radiation is too great or the mass flow of heat transfer medium is too low, then the evaporation end point 24 shifts in the direction of the start 21. This is indicated in FIG. 1(c) by the curve 18′. If the radiation is too low or the mass flow is too high, then the evaporation end point 24 shifts in the direction away from the start 21. This is indicated in FIG. 1(c) by the curve having the reference character 18″. A fluctuation of the mass flow and/or a fluctuation of the irradiation conditions leads to a continuous fluctuation of the evaporation end point 24.

In the case of the recirculation concept (which is represented schematically in FIG. 1(b)), a flow section 30 is divided into an evaporator branch 32 and a superheater branch 34. Between the evaporator branch 32 and the superheater branch 34 a separator 36 is disposed. An outlet of the evaporator branch 32 leads into the separator 36. The superheater branch 34 continues from the separator 36. A further outlet of the separator 36 is connected fluidically to a line 38. This line 38 in turn is connected fluidically to a start 40 of the evaporator branch 32. In the line 38 preferably a pump 42 is disposed. The line 38 forms a recirculation line, through which liquid heat transfer medium is recirculated from an outlet of the evaporator branch 32 to the start 40.

By means of the position of the separator 36 the evaporation end point is to a certain extent defined by hardware.

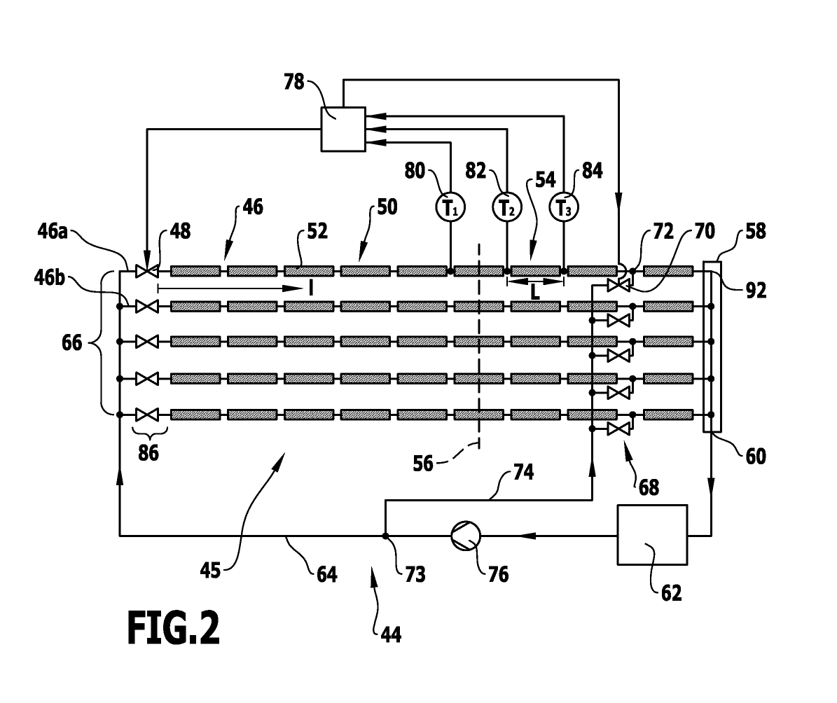

A first embodiment of a solar thermal power plant according to the invention, which is shown in FIG. 2 and denoted by 44, comprises a steam generating stage 45 having a plurality of flow sections 46 (46a, 46b, etc.) arranged in parallel. These are followed by an evaporator zone 50 having a solar collector device 52. The solar collector device 52 comprises for example a plurality of trough collectors.

The evaporator zone 50 is followed in the flow section 46 by a superheater zone 54. This is likewise disposed at the solar collector device 52. Situated between the evaporator zone 50 and the superheater zone 54 is the evaporation end point 56. This may be situated inside a trough collector. As is explained in greater detail below, the aim of the control method according to the invention is to fix the evaporation end point 56 spatially, i.e. along the flow section 10, and hence fix in position the evaporation end point 56.

Adjoining the superheater zones 54 of the flow sections 46 is a collecting device 58. In this, the superheated steam of the collector branches of the parallel flow sections 46 is collected.

The collecting device 58, which has inlets corresponding to the plurality of flow sections 46, is coupled by an outlet 60 fluidically to a power block 62. The power block 62 comprises (at least) a turbine and a generator of electric current.

From the power block 62 a return line 64 leads to a distributing device denoted as a whole by 66, by means of which the flow of liquid heat transfer medium is apportioned to the individual flow sections 46.

Associated with the superheater zone 54 is an injection device denoted as a whole by 68. By means of this device liquid heat transfer medium can be injected into the superheater zone 54 in order to be able to adjust an outlet temperature of superheated steam from the superheater zone 54. This is explained in greater detail below. Thus, the inlet temperature of superheated steam into the power block 62 can be fixed.

The injection device 68 comprises for example in each case a control valve 70 associated with the corresponding flow section 46. By means of such a control valve 70 the quantity of injected liquid heat transfer medium is adjustable (including the adjustment option that no liquid heat transfer medium is injected).

The injection device 68 has at the respective flow section 46 an injection point 72, which, as is explained in greater detail below, is disposed downstream of temperature sensors that provide temperature measured values for implementing the control method according to the invention.

Disposed on the line 64 is a junction 73, from which a line 74 branches off, to which in turn the control valves 70 of the respective flow sections 46 are connected fluidically. By means of the junction 73 liquid heat transfer medium may be tapped and used to inject into the superheater zones 54 of the flow sections 46.

At the return line 64 a pump 76 for feeding the heat transfer medium is disposed.

The solar thermal power plant 44 comprises a control device 78. By means of this device control is effected in such a way that the evaporation end point 56 is fixed in position.

At the evaporator region 50 a first temperature sensor 80 is disposed. This measures the temperature in the vaporous heat transfer medium. The first temperature sensor 80 is in this case disposed outside of a preheating zone.

In the superheater zone a second temperature sensor 82 and a third temperature sensor 84 are disposed spaced apart from one another. The corresponding spacing is denoted in FIG. 2 by L. This spacing may be greater than, equal to or smaller than the length of for example a trough collector. The second temperature sensor 82 and the third temperature sensor 84 are disposed, in relation to the flow direction of heat transfer medium in a flow section 46, upstream of the injection point 72. The first temperature sensor 80, the second temperature sensor 82 and the third temperature sensor 84 are connected in a signal effective manner to the control device 78. The corresponding temperature measured values (T₁, T₂, T₃) of these temperature sensors are transferred to the control device 78 for further evaluation and processing.

The control valves 48 of the flow section 46 form a mass flow control device 86. These control valves 48 allow an adjustability of the mass flow in the respective flow sections 46. The control valves 48 are activated by the control device 78, so that by means of the control device 78 the mass flow of heat transfer medium is adjustable.

The control device 78 is for example connected in a signal effective manner to the injection device 68 and in particular to the control valves 70 thereof. The control device 78 activates the control valves 70. For controlling the superheater injection a device that is separate from the control device 78 may also be provided.

In FIG. 2 the connections between the control device 78 and elements of the flow sections 46 are shown only for the flow section 46a. The same connections exist for the other flow sections.

According to the invention superheated steam is generated as follows:

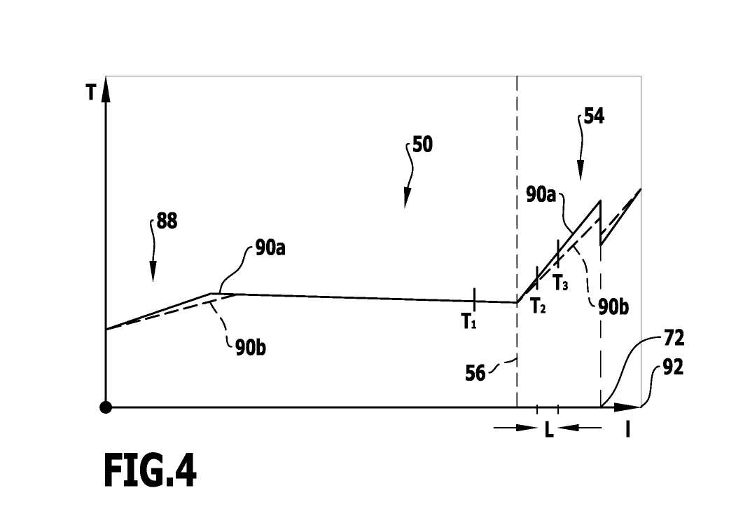

Liquid heat transfer medium (in particular feed water) is apportioned to the individual parallel flow sections 46. In the respective flow sections 46 heat transfer medium is preheated in a preheating zone 88 (FIG. 4). In this zone the heat transfer medium absorbs substantially sensible heat.

Adjoining the preheating zone 88 is the evaporator zone 50. In this zone the heat transfer medium absorbs substantially latent heat. An evaporation occurs. In the superheater zone 54 the superheating occurs.

The temperature T₁ is measured by the first temperature sensor 80 upstream of the evaporation end point 56. The second temperature sensor 82 measures the corresponding temperature T₂ and the third temperature sensor 84 measures the temperature T₃ in the superheater zone 54 downstream of the evaporation end point 56.

The control device 78 determines the gradients ΔT/L=(T₃−T₂)/L in the superheater zone 54. The temperature value T₁ is extrapolated in the direction of greater lengths l and the gradient in the direction of smaller lengths. The point of intersection is determined. This point of intersection corresponds to an actual value of the position of the evaporation end point 56. The distance from the setpoint value (reference variable), namely the preselected position of the evaporation end point 56, is determined. This distance in turn determines a manipulated variable for influencing the mass flow at the corresponding flow section 46. The manipulated variable is for example a valve lift of the corresponding control valve 48. In accordance with the deviation, in a continuous control process the mass flow is lowered or raised in order to adjust the actual value to the setpoint value. The mass flow at each flow section 46 is adjusted on the basis of the determined temperature gradient ΔT/L and the measured temperature T₁ in order locally to fix the evaporation end point 56. This fixing in position is to a certain extent a “software fixing”.

In FIG. 4 a first case with high radiation is schematically shown by the reference character 90a and a second case with low radiation is schematically shown by the reference character 90b in the temperature characteristic over the length l. The case with lower radiation (90b) has a longer preheating zone. The gradient in the superheater zone 54 is smaller than for the case 90a. This entails for the case 90b, in comparison to the case 90a, lowering the mass flow in the corresponding flow section 46.

The control device 78 also controls the injection device 68. The aim is at an outlet 92 of the flow section 46 and hence at the outlet of the superheater zone 54 to adjust and also fix a specific temperature (adapted to the turbine of the power block 62). This may be effected by controlled injection of a specific quantity of liquid heat transfer medium

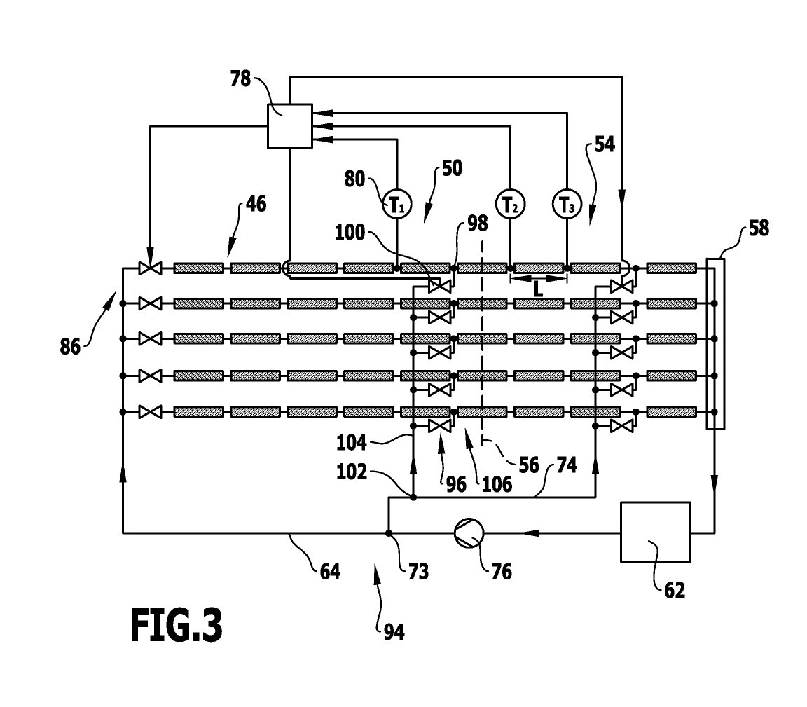

A second embodiment of a solar thermal power plant according to the invention that is shown schematically in FIG. 3 and denoted there by 94 is in principle identical in construction to the solar thermal power plant 44. For identical elements identical reference characters are used. An additional injection device 96 is provided, by means of which liquid heat transfer medium is injectable into the evaporator zone 50. In this case, at the respective flow sections 46 an injection point 98 is disposed in the evaporator zone 50 downstream of the first temperature sensor 80, i.e. the respective injection point 98 lies between the first temperature sensor 80 and the evaporation end point 56.

The injection device comprises for example a control valve 100 associated with each flow section 46. The control valves 100 are connected fluidically to the return line 64. For example from a junction 102 a line 104 leads to the control valves 100 of the flow sections 46. The junction 102 in turn is disposed for example on the return line 64 or on the line 74.

The control device 78 activates the injection device 96 comprising the control valves 100.

The injection device 96 forms a mass flow control device. By means of this device the mass flow of heat transfer medium in the flow section 46 may be influenced. The control valves 48 then form a first mass flow control device 86 and the injection device 96 forms a second mass flow control device 106.

By virtue of the injection device 96, i.e. by virtue of providing the second mass flow control device 106, it is possible to improve the control quality and increase the speed of control.

With the solution according to the invention the evaporation end point 56 may be fixed in position by means of a control method in order to minimize oscillations of the evaporation end point 56 in the event of fluctuating solar energy input. The flow sections arranged in parallel are collector branches. For each collector branch (for each flow section 46) the evaporation end point 56 is fixed.

By extrapolating the determined temperature gradient in the evaporator zone 54 in the collector branch inlet direction an actual value for the evaporation end point is determined for adjustment to the setpoint value (reference variable). What is controlled in this case is the mass flow of heat transfer medium in the respective collector branch, i.e. in the respective flow section 60. The mass flow is realized in this case by adjusting the quantity of liquid heat transfer medium that is injected into the respective flow section 60. This is effected primarily by means of the first mass flow control device 46 comprising the control valves 48. In addition, a second mass flow control device 106 comprising the control valves 100 may be additionally provided.

With the solution according to the invention, the measured temperature T₁ is additionally determined in order to determine the actual value of the evaporation end point. The result is therefore stable control and during real operation the range of fluctuation of the evaporation end point 56 may be restricted to a very small range.

By virtue of an additionally provided injection at corresponding injection points 98 it is possible to improve the control quality and sharply increase the speed of control.

As a result of the fixing of the evaporation end point 56 a control of the outlet temperature of the respective collector branches is necessary. In connection therewith, control is effected in particular to a constant outlet temperature.

The solution according to the invention is more economical to realize than a solution according to the recirculation concept. Furthermore, lower heat losses of the overall system arise. In principle it is possible to adjust the local position of the evaporation end point 56 “by software” and for example also shift it closer to the start of a collector branch. The result is low material stresses and hence also longer potential plant operation combined with improved controllability.

1. A method of generating superheated steam in a solar thermal power plant, in which in a flow section for heat transfer medium steam is generated by solar energy in an evaporator zone and the steam is superheated by solar energy in a superheater zone, comprising:
fixing in position an evaporation end point of the evaporator zone in a control method, in which a spatial temperature gradient in the superheater zone and a temperature in the evaporator zone are determined and the mass flow of heat transfer medium in the flow section is adjusted in dependence upon the temperature gradient and the measured temperature in the evaporator zone.

2. The method according to claim 1, wherein for fixing the evaporation end point the mass flow of the heat transfer medium in the flow section is controlled.

3. The method according to claim 1, wherein a controlled variable in the control method is the spatial position of the evaporation end point, and a reference variable is a defined location.

4. The method according to claim 1, wherein a manipulated variable in the control method determines the mass flow of the heat transfer medium in the flow section.

5. The method according to claim 1, wherein in the control method the temperature gradient and the measured temperature in the evaporator zone are extrapolated to a spatial point of intersection and one or more manipulated variables are determined by means of a deviation of the point of intersection from a predetermined spatial position of the evaporation end point.

6. The method according to claim 1, wherein the temperature in the evaporator zone is measured outside of a preheating zone.

7. The method according to claim 1, wherein the temperature gradient is determined from the measured temperatures at at least two spaced-apart locations in the superheater zone.

8. The method according to claim 1, wherein liquid heat transfer medium is injected in a controlled manner into the evaporator zone.

9. The method according to claim 8, wherein the injection is effected between the temperature measuring point and the evaporation end point.

10. The method according to claim 1, wherein an outlet temperature at the superheater zone is controlled to a constant value.

11. The method according to claim 10, wherein liquid heat transfer medium is injected in a controlled manner into the superheater zone.

12. A solar thermal power plant having a steam generating stage, comprising:
at least one collector branch having a flow section for heat transfer medium comprising an evaporator zone and a superheater zone;
a first temperature sensor that is disposed at the evaporator zone;
a second temperature sensor and a third temperature sensor that are disposed spaced apart from one another at the superheater zone;
a mass flow control device, by means of which the mass flow of heat transfer medium in the flow section is adjustable; and
a control device that is connected in a signal effective manner to the first temperature sensor, the second temperature sensor and the third temperature sensor, determines from a second temperature and a third temperature a spatial temperature gradient and controls the mass flow control device in order to fix an evaporation end point.

13. The solar thermal power plant according to claim 12, wherein there is disposed at a start of the flow section a control valve, which is controlled by the control device.

14. The solar thermal power plant according to claim 12, wherein an injection device is provided for injecting liquid heat transfer medium by means of at least one injection point into the evaporator zone.

15. The solar thermal power plant according to claim 14, wherein the injection device is controlled by the control device.

16. The solar thermal power plant according to claim 14, wherein the injection device comprises a control valve.

17. The solar thermal power plant according to claim 14, wherein the at least one injection point of the injection device lies between a temperature measuring point of the first temperature sensor and the evaporation end point.

18. The solar thermal power plant according to claim 12, wherein an injection device is provided for injecting liquid heat transfer medium by means of at least one injection point into the superheater zone.

19. The solar thermal power plant according to claim 12, comprising a solar collector device, at which the flow section is disposed.

20. The solar thermal power plant according to claim 12, wherein the steam generating stage is fluidically connected to at least one turbine.

21. The solar thermal power plant according to claim 12, wherein by means of the control device there is implemented a steam generating method comprising:
fixing in position an evaporation end point of the evaporator zone in a control method, in which a spatial temperature gradient in the superheater zone and a temperature in the evaporator zone are determined and the mass flow of heat transfer medium in the flow section is adjusted in dependence upon the temperature gradient and the measured temperature in the evaporator zone.
